(19) United States
(12) Patent Application Publication
(10) Pub. No.: US 2013/0160336 A1
(43) Pub. Date: Jun. 27, 2013

(54) DISPLAY DEVICE FOR VEHICLES

(71) Applicant: RONALD C. HARMAN, JR., Durham, NC (US)

(72) Inventor: RONALD C. HARMAN, JR., Durham, NC (US)

(21) Appl. No.: 13/723,535

(22) Filed: Dec. 21, 2012

Related U.S. Application Data
(60) Provisional application No. 61/579,073, filed on Dec. 22, 2011.

(51) Int. Cl. G09F 21/04; G09F 13/00

(52) U.S. Cl. CPC G09F 21/04; G09F 13/00
USPC 40/559; 40/591

(57) ABSTRACT

A display device for mounting on a vehicle is disclosed. In some embodiments, the display device comprises a plurality of bases removably attached to a vehicle and a display material removably connected to the plurality of bases, wherein content on the display material is visible regardless of the vehicle's velocity. The plurality of bases is adjustable for accommodating display materials of different widths and heights.

### CLAIM OF PRIORITY UNDER 35 U.S.C. §119

The present Application for Patent claims priority to and the benefit of the filing date of U.S. Provisional Application No. 61/579,073, entitled “DISPLAY DEVICE FOR VEHICLES” filed Dec. 22, 2011, and hereby expressly incorporated by reference herein.

### BACKGROUND

Currently, removable devices used to display information on vehicles are limited. There are two core types of mechanisms. Those that attach to the windows, such as “flags”, and those that magnetically adhere to the roof top, such as a “pizza box”. Both have drawbacks.

The flag model is a single base unit and unable to display information unless the vehicle is in motion or there is wind significant enough to lift the flag. Additionally, the flags are attached to the base and not made to be interchangeable. Finally, the space allocated for information is limited and does not provide the adjustability, i.e., in width and height by design. Examples of “flag” inventions are shown in U.S. Pat. Nos. 4,519,153 and 5,084,994.

The “pizza top” mechanism uses a fixed, single base system to display a rigid sign. This model does not easily collapse for easy removal and storage. While the part of the device that is customized, the insert, can be replaced, the rigid sign is fixed in size and cannot adapt to different sizes. Instances are shown in U.S. Pat. Nos. 4,292,627 and 7,121,700.

### SUMMARY

The present invention serves as a removable display device for vehicles. In some embodiments, the display device is intended for use by individuals and companies to convey information via vehicles to the general public.

In some embodiments, the display device for mounting on a vehicle comprises a plurality of bases removably attached to a vehicle and a display material removably connected to the plurality of bases, wherein content on the display material is visible regardless of the vehicle's velocity. The plurality of bases is adjustable for accommodating display materials of different sizes, such as different widths and heights.

In some embodiments, the plurality of bases is removably attached to the vehicle via magnets.

In some embodiments, the display material is canvas.

In some embodiments, at least two of the plurality of bases are removably interlocked when attached to the vehicle.

In some embodiments, the display device comprising the plurality of bases and the display material collapses into a manageable package. In some embodiments, the plurality of bases fit together for easy storage.

The features, functions, and advantages that have been discussed may be achieved independently in various embodiments or may be combined with yet other embodiments, further details of which can be seen with reference to the following description and drawings.

### BRIEF DESCRIPTION OF THE DRAWINGS

Having thus described embodiments of the present invention in general terms, reference will now be made to the accompanying drawings, which are not necessarily drawn to scale, and wherein:

FIG. 1 is a perspective view illustrating a display device attached to a vehicle according to one embodiment of the present invention;

FIG. 2 is a perspective view of the display device according to one embodiment of the present invention;

FIG. 3 is a perspective of the top of the base of the display device according to one embodiment of the present invention; and

FIG. 4 is a perspective view of the bottom of the base of the display device according to one embodiment of the present invention.

### DETAILED DESCRIPTION

The following detailed description refers to the accompanying drawing, which illustrates specific embodiments of the invention. Other embodiments having different structures and operation do not depart from the scope of the present invention. The embodiments herein are provided so that this disclosure will satisfy applicable legal requirements. Where possible, any terms expressed in the singular form herein are meant to also include the plural form and vice versa unless explicitly stated otherwise. Also, as used herein, the term “a” and/or “an” shall mean “one or more,” even though the phrase “one or more” is also used herein. Like numbers refer to like elements throughout.

The present invention serves as a removable display device for vehicles. In some embodiments, the display device is intended for use by individuals and companies to convey information via vehicles to the general public, for example by utilizing space above the roof of the vehicle. However, the display device may be used anywhere on the vehicle, such as on the rear/trunk of the vehicle, on the hood of the vehicle, in the bed of the vehicle, or any other location desired by the user. An advantage of the display device is that it can be configured for use on vehicles having different dimensions for supporting displayed information. For example, the display device may be configured to display an advertisement on the top of a truck cab by placing the display device bases closer together, but then a user could detach the display device from the truck cab top and place the display device on a larger surface of a van, thus allowing the user to display a larger advertisement.

In some embodiments, the display device for mounting on a vehicle comprises a plurality of bases removably attached to a vehicle and a display material removably connected to the plurality of bases, wherein content on the display material is visible regardless of the vehicle's velocity. The plurality of bases is adjustable for accommodating display materials of different widths and heights. In some embodiments, poles are used to connect the display material to the plurality of bases. In some embodiments, the plurality of bases is made of plastic.

In some embodiments, the plurality of bases is removably attached to the vehicle via magnets. However, other forms of attachment can be used, including suction or attachment to roof racks. One of ordinary skill in the art recognizes that other means of removably attaching the plurality of bases are possible, such as, for example, brackets or adhesive, may be used to attach to the vehicle.

The display material is a flexible material on which content such as a written message, an image, or any sort of graphic conveying information is placed. The display material is suitable for receiving the content and displaying the content. In some embodiments, the display material is, for example, a textile product, fabric, paper, plastic or wood. In some embodiments, the display material is canvas. In some embodiments, the display material is treated with a coating to make it weatherproof or waterproof. In some embodiments, the display material is easily adjusted or adapted to different sizes and shapes, enabling formation of displays of different sizes.

In some embodiments, the display device, including the plurality of bases and the display material, easily disassembles and collapses into a manageable package. In some embodiments, the plurality of bases fit together for easy storage. In some embodiments, the display device is easily dismantled and stored in the vehicle. In at least some embodiments, the display device is sturdy and light weight.

In some embodiments, the display device is left mostly intact on the vehicle, but the display material is unfastened on one end and rolled up into a holder on one side for storage.

The plurality of bases is made of any suitable material, including but not limited to plastic, metal, and wood. The plurality of bases is sturdy enough to hold a display material securely when the vehicle is traveling. In an embodiment, the plurality of bases is able to hold a display material securely when the vehicle is stationary or when the vehicle is traveling up to standard driving speeds on roads and highways. For example, the plurality of bases is able to hold a display material securely when the vehicle is traveling up to 70 miles per hour.

In some embodiments, each of the plurality of bases is mounted on the vehicle so that it is not touching any other base. The number of bases can be any number, such as two bases, three bases, four bases, five bases, six bases, or any other number of bases desired. One of ordinary skill in the art understands that different numbers of bases can be used in the display device, and the display device will still fall within the scope of the present invention.

In some embodiments, the plurality of bases is mounted on the vehicle so that there is interlocking of at least two of the individual base units. The plurality of based may be interlocked by attachment of a display material to each base. For example, a display material may be stretched between the bases or display devices and then attached to each such that the display devices are interlocked with one another. In another embodiment, the bases are interlocked based on a wire or horizontal post, such as one attached at the base, at the top, or at any portion the base and the top of the display devices.

The display device of the present invention is adjustable. The plurality of bases is adjustable for accommodating display materials of different widths and heights. Further, the plurality of bases enables unique configuration and placement options of the display device upon the vehicle. The base units making up the plurality of bases can be of the same size or can be of different sizes. The display material can also be of various sizes, resulting in a highly adjustable display device system. One of ordinary skill in the art recognizes that while many different shapes and sizes of the base units and the display material are possible, all would fall within the scope of the present invention.

The display device of the present invention is held erect and the displayed content is visible regardless of the velocity of the vehicle. Thus, the content is viewable when the vehicle is driving in town at modest speeds, at increased speeds on the highway, and even when the car is at a standstill at a stoplight or parked in a parking lot. The display device is attached securely enough to the vehicle that it withstands highway speeds. In some embodiments, the display device is used only when the vehicle is at a stop, such as parked in a parking lot, thus providing more options as to the placement of the display device on the vehicle without regard to safety concerns that arise when using the display device while driving.

In some embodiments, the display device comprises lights so that the content is visible in dark conditions. In some embodiments, lights are provided inside the appendage of the display device nearest the front of the vehicle, wherein the lights are spaced so as to provide illumination of both sides of the display material and wherein the light beams are directed towards the content on the display material. In some embodiments, light strips are adhered to the roof of the vehicle so that they are parallel to the display device and so that the light is projected toward the content on the display device. In at least some embodiments, the light strips are removably adhered to the vehicle roof. The lights used to illuminate the sign can be powered by any known power source, such as but not limited to a battery, a solar power source, or a voltage plug that connects to the vehicles cigarette lighter through the vehicle window.

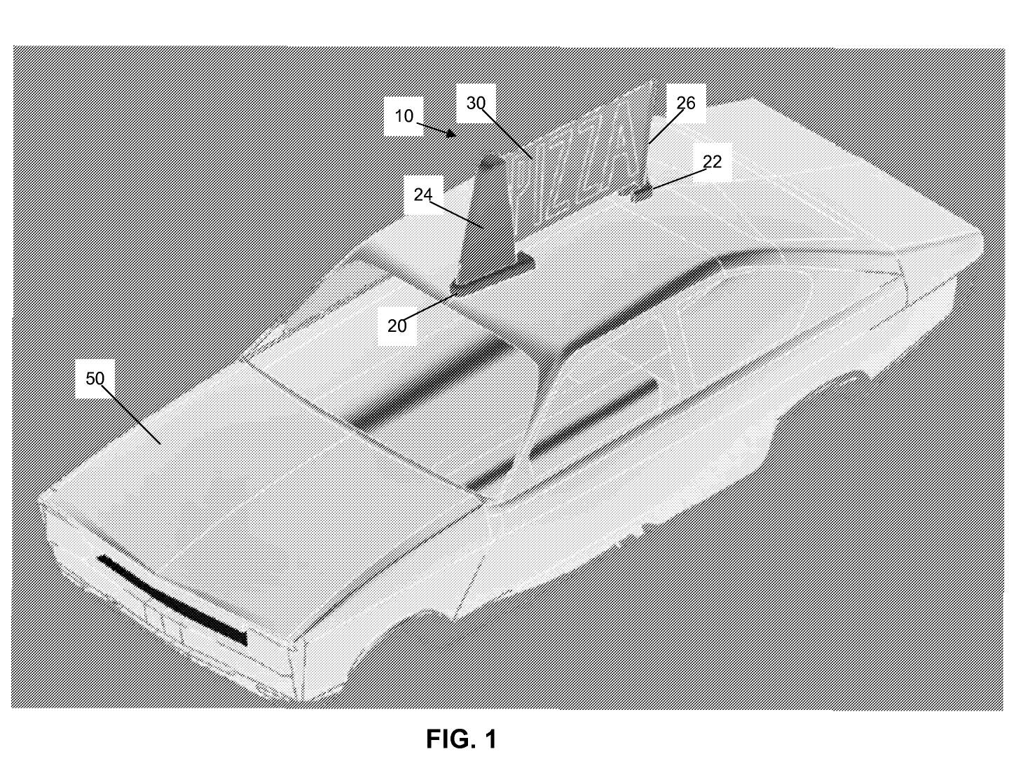

As shown in FIG. 1, the display the device of the present invention can be mounted on the roof of a vehicle 50, such as a passenger car. As seen in FIG. 1, the display device 10 has a plurality of bases 20 and 22, and a display material 30.

The plurality of bases 20 and 22 include upward appendages 24 and 26 that serve to hold the display material 30 in a position such that the content on the display material (“PIZZA”) is readable while the display device 10 is mounted on the vehicle 50.

In the embodiment shown in FIG. 1, the display material 30 can be disconnected from appendage 26 and rolled up, similar to a window shade, to be stored inside of appendage 24 without removing the entire display device 10 from its mounted position on the vehicle. Thus, in case of inclement weather or dirty environmental conditions, the display material is protected without disassembling the entire display device.

As can be appreciated from FIG. 1, the display device of the present invention offers great adaptability to use with display materials of different sizes. For example, assume that display material 30 of display device 10 has a height of one foot and a length of three feet. The user of the display device can opt to use a different display material 30, such as one displaying an image of a pizza. A display material containing an image of a pizza, with dimensions of one foot in height and two feet in length, is easily accommodated by the display device 10 as shown in FIG. 1. The user simply moves the base unit 22 from a position three feet away from base unit 20 to a position two feet away from base unit 20.

The display device of the present invention is used by both businesses and private consumers. The display material can convey any desired content or message, including advertisements for businesses, signs for delivery cars, and personal signs such as announcements of graduations, birthdays, holidays, and U.S. flags. Further, the display devices can be used to promote college and professional sports teams, either as advertising or simply in a show of team spirit. Many other uses are envisioned and fall within the scope of the present invention.

In some embodiments, the components of the display device are sold separately and the base units can be used interchangeably or in any combination. In some embodiments, the plurality of bases and the display material are sold as a kit. Additional display materials are purchased by users who have already purchased the plurality of bases. Additional base units of different sizes can also be purchased. In some embodiments, there is a website that offers buyers the ability to log in, upload graphics and text to create custom content, and create a display material with the custom content.

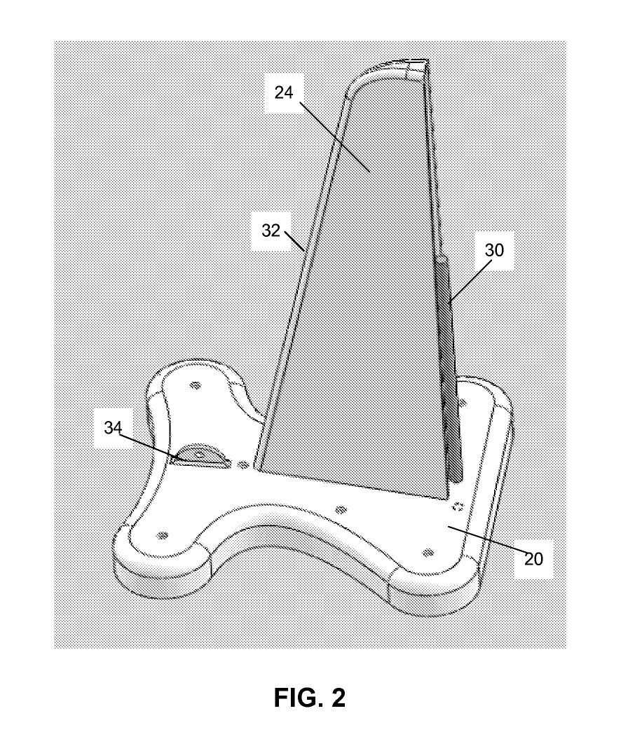

Turning now to FIG. 2, a perspective view of the display device 10 is provided in accordance with an embodiment of the invention. In FIG. 2, the upward appendage 24 is attached to the base 20. In some embodiments, the upward appendage includes a wind shear 32 and a pole (not shown). The wind shear 32 is an aerodynamic structure that surrounds the pole and, in some embodiments, the display material 30 such that wind is directed to side of the pole and the display material when the vehicle is in motion. In some embodiments, when multiple display devices, e.g., a front and a back display device, are attached to a vehicle, only the front display device includes the wind shear 32.

In some embodiments, the base 20 of the display device 10 includes a hook 34. The hook 34 can be used as an additional attachment point for the display device. For example, a wire can be attached from the hook 34 to one or more positions on the vehicle to safely secure the device in case the primary attachments devices, e.g., magnets, detaches.

As discussed herein and disclosed in FIG. 2, the display material 30 may be rolled up into one display device. The display material may roll clockwise or counter-clockwise around the pole inside of the upward appendage 24. In some embodiments, a portion of the display material 30 protrudes from the upward appendage 24 even when the display material 30 is rolled up so that a user may easily take hold of the display material to unroll and display it.

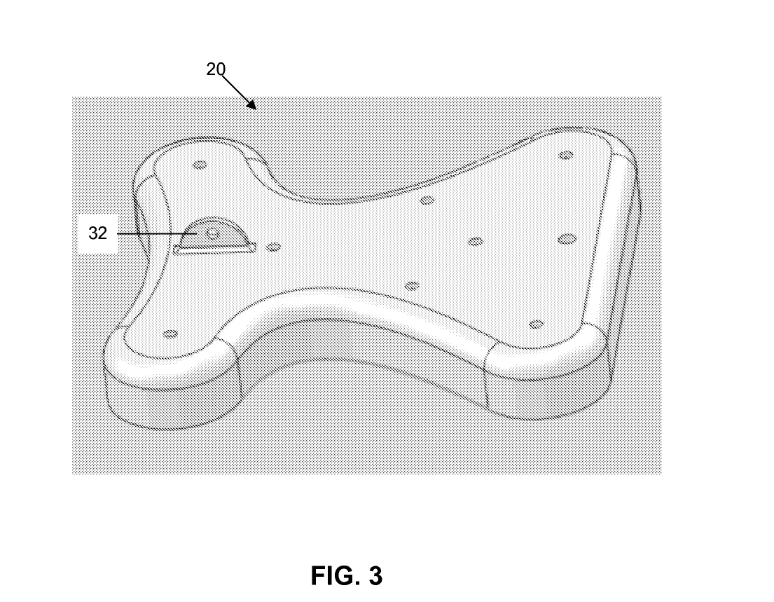

FIG. 3 discloses the base 20 of the display device 10 in an embodiment. The base may be configured in an hourglass shape and have multiple attachment points for attachment of the device to the vehicle. In some embodiments, a widened based provides a more secure attachment of the display device to the vehicle. For example, a widened base supports the display device both in the direction of travel of the vehicle and from forces acting perpendicular to the direction of travel of the vehicle, such as wind blowing perpendicular to the direction of travel of the vehicle.

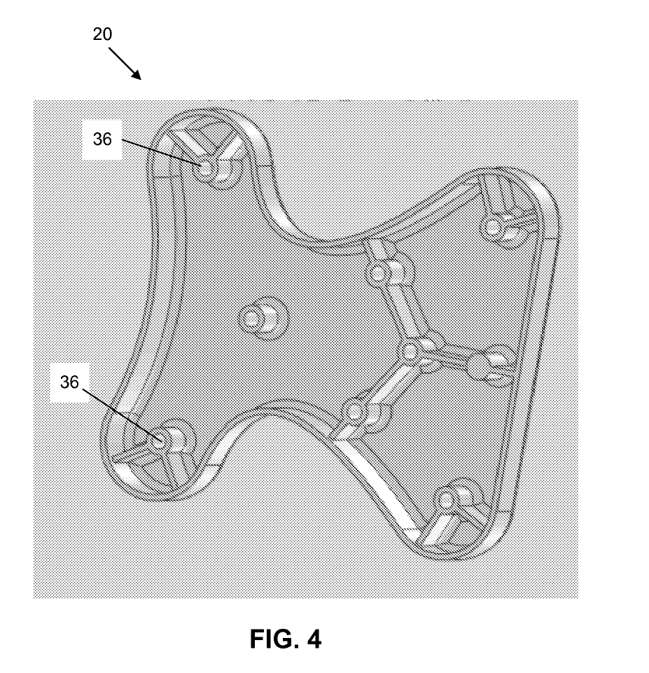

FIG. 4 discloses a bottom view of the base 20 of the display device 10 in an embodiment. In this view, exemplary attachment points 36 for attachment devices such as magnets are depicted. It should be understood that this is merely an exemplary embodiment, and the display device may be attached to vehicle in numerous ways as described herein.

Specific embodiments of the invention are described herein. Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A display device for mounting on a vehicle comprising:
a plurality of bases removably attached to a vehicle; and
a display material removably connected to the plurality of bases, wherein content on the display material is visible when the vehicle is stationary and when the vehicle is in motion.

2. The display device of claim 1, wherein the plurality of bases is adjustable for accommodating display materials of different sizes.

3. The display device of claim 1, wherein the plurality of bases is removably attached to the vehicle via magnets.

4. The display device of claim 1, wherein the display material is selected from the group consisting of a textile product, a fabric, a paper product, a plastic product or a wood product.

5. The display device of claim 1, further comprising a light for illuminating the display material.

6. The display device of claim 1, wherein the plurality of bases is collapsible.

7. The display device of claim 1, wherein at least two of the plurality of bases are removably interlocked when attached to the vehicle.

8. The display device of claim 1, further comprising a wind shear positioned on the base and configured to aerodynamically direct wind around the display material.

9. The display device of claim 1, further comprising a hook on the base, wherein the hook is configured to provide an attachment point to the vehicle on which the display device is mounted.

10. The display device of claim 1, wherein the display material is configurable between an extended position and a rolled up position.

11. A display device for mounting on a vehicle comprising:
a base comprising at least one attachment device for attaching the base to a vehicle;
an upward appendage attached to the base; and
a display material attached to the upward appendage and configured to roll into the upward appendage for storage or extend from the upward appendage for display.

12. The display device of claim 11, further comprising a second base and a second upward appendage, wherein the display material is configured to extend from the first upward appendage to the second upward appendage for display.

13. The display device of claim 11, further comprising a wind shear positioned on the upward appendage and configured to aerodynamically direct wind around the display material.

14. The display device of claim 11, further comprising a hook on the base, wherein the hook is configured to provide an attachment point to the vehicle on which the display device is mounted.

15. The display device of claim 11, wherein the display material is selected from the group consisting of a textile product, a fabric, a paper product, a plastic product or a wood product.

16. The display device of claim 11, further comprising a light for illuminating the display material.

17. The display device of claim 11, wherein the at least one attachment device is a magnet.

18. A method of mounting a display device on a vehicle comprising;
removably attaching a plurality of bases to a vehicle in a desired configuration;
removably connecting a display material to a plurality of bases so that content on the display material is visible when the vehicle is stationary and when the vehicle is in motion.

19. The method of claim 18, wherein the removably attaching a plurality of bases to the vehicle comprises attaching the plurality of bases to the vehicle via at least one magnet.

20. The method of claim 18, wherein the plurality of bases are configurable in more than one desired configuration.
